(19) United States
(12) Patent Application Publication
(10) Pub. No.: US 2015/0002616 A1
(43) Pub. Date: Jan. 1, 2015

(54) APPARATUS AND METHOD FOR PROCESSING MULTICAST TRAFFIC IN OPENFLOW ENVIRONMENT

(71) Applicant: Electronics and Telecommunications Research Institute, Daejeon (KR)

(72) Inventors: Hyeonsik YOON, Daejeon (KR); Hae Sook PARK, Daejeon (KR)

(73) Assignee: Electronics and Telecommunications Research Institute, Daejeon (KR)

(21) Appl. No.: 14/177,760

(22) Filed: Feb. 11, 2014

(30) Foreign Application Priority Data
Jun. 27, 2013 (KR) 10-2013-0074474

(51) Int. Cl. H04N 7/15

(52) U.S. Cl. CPC H04N 7/152
USPC 348/14.09

(57) ABSTRACT

An apparatus for processing multicast traffic in an OpenFlow environment, includes: a network topology and configuration information management unit configured to generate network topology and related switch configuration information based on switch configuration information received from one or more OpenFlow switches. Further, the apparatus includes a path information processing unit configured to, when traffic for video conference service is received, generate ring-type transmission path information to be used to process the traffic, based on the network topology and related switch configuration information, and set the ring-type transmission path information in one or more OpenFlow switches to be used for the video conference service, thereby setting up a ring-type transmission path.

### CROSS-REFERENCE TO RELATED APPLICATION(S)

The present invention claims priority of Korean Patent Application No. 10-2013-0074474, filed on Jun. 27, 2013, which is incorporated herein by reference.

### FIELD OF THE INVENTION

The present invention relates to traffic control in an OpenFlow environment and, more particularly, to an apparatus and method that are capable of setting up a ring-type transmission path via OpenFlow switches and transmitting multicast traffic through the ring-type transmission path.

### BACKGROUND OF THE INVENTION

In general, in order to provide a multiparty video conference service in a company, connections should be set up between the participants of a conference. Methods of setting up connections between the participants of a multiparty video conference in conventional network equipment include a unicast method and a multicast method. A unicast method is configured to set up connections between all conference participants in a full mesh manner. In the case of a router, a transmission path is set up by the operation of a routing protocol, such as OSPFv2, or BGP4. In contrast, a multicast method is configured to generate a multicast tree in which each participant has been set as a sender and the other participants have been set as recipients for each participant. In the case of a router, a transmission path is set up by the operation of a protocol, such as PIM-SM or IGMP.

However, the unicast method is problematic in that the use of bandwidth is excessive because N*(N−1)/2 links are required when the number of participants in a conference is N, and the multicast method is also problematic in that N multicast trees are required and also PIM-SM may jeopardize the stability of a network.

Recently, research into OpenFlow technology has been actively carried out in an effort to change existing closed networking technology into open networking technology.

OpenFlow technology was first developed by the initiative of Stanford University. The Open Networking Foundation (ONF) has extended OpenFlow technology to software-defined networking (SDN) technology and has standardized it since ONF, that is, a standardization organization, was established in March 2011.

ONF was founded by Deutsche Telecom, Facebook, Google, Microsoft, Verizon, and Yahoo!. ONF is a nonprofit standardization organization, and is dedicated to the reinterpretation of networking technology as computing technology and the rapid provision of standardization and solutions that are required by the market.

OpenFlow technology separates the packet forwarding and control function of a network switch (or a router) into two functions and provides a protocol that is used for communication between these two functions. Accordingly, software that is run by an external controller (a server) can determine a packet transmission path inside a switch regardless of the vendor of equipment. This separation of the packet forwarding function and the control function enables more precise traffic management than an ACL or a routing protocol in conventional network equipment.

Recently, with the development of information communication technology, the demand for services using multicast traffic between remote parties, for example, a video conference service, has increased. However, conventional video conference service systems are problematic in that the systems should be built at specific locations at enormous expenses. In order to overcome this problem, it is necessary to provide a service in which participants can utilize a video conference via their own terminals using information and communication technology.

### SUMMARY OF THE INVENTION

In view of the above, the present invention provides an apparatus and method that are capable of setting up a ring-type transmission path via OpenFlow switches and transmitting multicast traffic through the ring-type transmission path when it is necessary to process multicast traffic over a network, as in a multiparty video conference service.

Further, the present invention provides an apparatus and method that are capable of processing multicast traffic through a ring-type transmission path, thereby providing multiparty video conference service in an OpenFlow environment.

In accordance with a first aspect of the present invention, there is provided an apparatus for processing multicast traffic in an OpenFlow environment. The apparatus includes a network topology and configuration information management unit configured to generate network topology and related switch configuration information based on switch configuration information received from one or more OpenFlow switches; and a path information processing unit configured to, when traffic for video conference service is received, generate ring-type transmission path information to be used to process the traffic, based on the network topology and related switch configuration information, and set the ring-type transmission path information in one or more OpenFlow switches to be used for the video conference service, thereby setting up a ring-type transmission path.

Further, the path information processing unit may generate the ring-type transmission path information that guarantees Quality of Service (QoS) while satisfying required bandwidth requirements.

Further, the apparatus may further comprise a channel setting and management unit configured to set up security channels with the OpenFlow switches and transmit and receive data over the security channels.

In accordance with a second aspect of the present invention, there is provided an apparatus for processing multicast traffic in an OpenFlow environment. The apparatus includes a flow table configured such that transmission path information used to process external traffic has been set therein; and a path setting unit configured to, when traffic that does not match the flow table is received, transmit the received traffic to a controller, receive transmission path information to be used to process the traffic from the controller, set the received transmission path information in the flow table, and set up a ring-type transmission path with one or more OpenFlow switches related to the traffic based on the transmission path information set in the flow table.

Further, the apparatus may further comprise a traffic processing unit configured to copy the original packet corresponding to the received traffic, and to transmit the original packet to a terminal corresponding to a destination and also transmit the copied packet to one or more other OpenFlow switches on the ring-type transmission path. Further, the packet corresponding to the received traffic may be transmitted to a terminal that transmitted the received traffic, through the ring-type transmission path.

Further, the apparatus may further comprise a channel setting and management unit configured to operate in conjunction with the controller over a Secure Socket Layer (SSL)-based security channel.

Further, the received traffic may be multicast traffic for a video conference.

In accordance with a third aspect of the present invention, there is provided a method In accordance with a third aspect of the present invention, there is provided a method of processing multicast traffic in an OpenFlow environment. The method includes, when multicast traffic is received from an outside source, requesting transmission path information that is used to process the multicast traffic; receiving ring-type transmission path information in response to the request; and setting up a ring-type transmission path with one or more other OpenFlow switches for processing of the multicast traffic using the ring-type transmission path information; wherein the multicast traffic is processed through the ring-type transmission path.

Further, the requesting transmission path information may comprise determining whether the transmission path information to be used to process the multicast traffic is present in a flow table; and if the transmission path information is not present in the flow table, requesting the transmission path information.

Further, the method may further comprise copying the original packet corresponding to the multicast traffic, and then transmitting the original packet to a terminal corresponding to a destination address of the traffic; and transmitting the copied packet to other OpenFlow switches on the ring-type transmission path.

Further, the packet corresponding to the multicast traffic may be transmitted to a terminal that transmitted the multicast traffic, through the ring-type transmission path.

Further, the method may further comprise obtaining configuration information from a plurality of OpenFlow switches, and generating network topology and configuration information based on the configuration information; when traffic for a video conference is received, generating ring-type transmission path information based on the network topology and configuration information; and setting up a ring-type transmission path by setting the generated ring-type transmission path information in one or more OpenFlow switches for the video conference.

Further, the generating ring-type transmission path information may comprise generating the ring-type transmission path information that guarantees Quality of Service (QoS) while satisfying required bandwidth requirements.

### BRIEF DESCRIPTION OF THE DRAWINGS

The above and other objects and features of the present invention will become apparent from the following description of embodiments given in conjunction with the accompanying drawings, in which:

FIG. 1 is a diagram illustrating the configuration of a system for providing OpenFlow-based video conference service according to an embodiment of the present invention;

FIG. 2 is a diagram illustrating a ring-type transmission path structure that is established according to an embodiment of the present invention;

FIG. 3 is a block diagram illustrating the internal configuration of an OpenFlow switch according to an embodiment of the present invention;

FIG. 4 is a flow chart illustrating the operation of the OpenFlow switch according to an embodiment of the present invention;

FIG. 5 is a block diagram illustrating the internal configuration of a controller according to an embodiment of the present invention;

FIG. 6 is a flow chart illustrating the operation of the controller according to an embodiment of the present invention; and

FIGS. 7A and 7B are flow charts illustrating a process of providing video conference service according to an embodiment of the present invention.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, embodiments of the present invention will be described in detail with reference to the accompanying drawings so that they can be readily implemented by those skilled in the art.

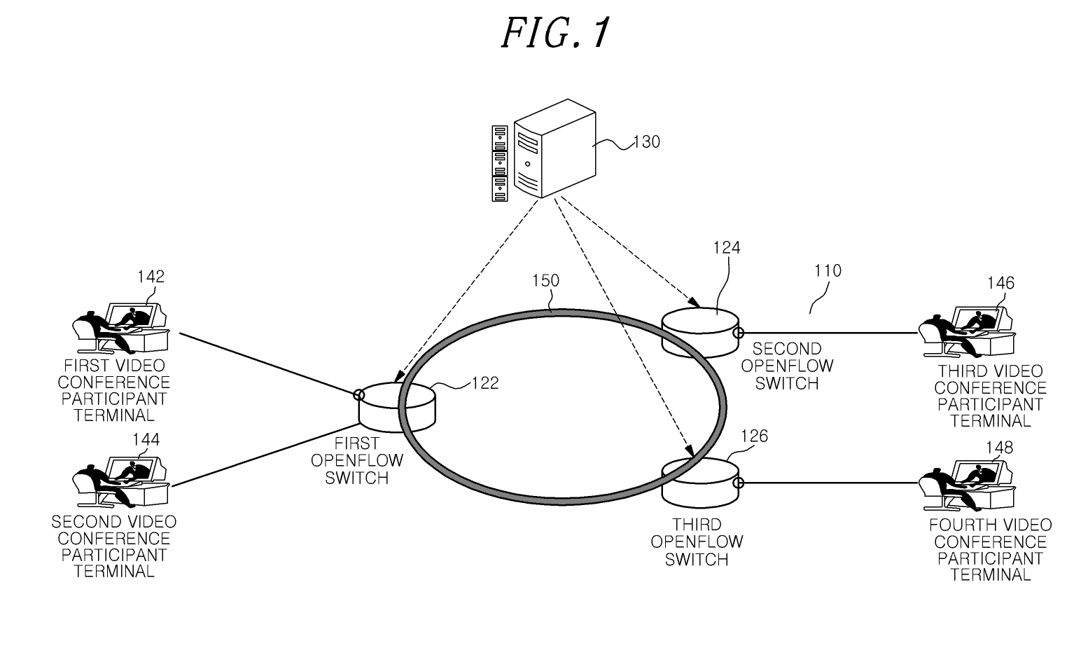

FIG. 1 is a diagram illustrating the configuration of a system for providing OpenFlow-based video conference service according to an embodiment of the present invention. The system for providing OpenFlow-based video conference service may include first, second and third OpenFlow switches 122, 124 and 126 configured to be present on a network 110, a controller 130 configured to control the first, second and third OpenFlow switches 122, 124 and 126, and first, second, third and fourth video conference participant terminals 142, 144, 146 and 148.

In the system for providing OpenFlow-based video conference service according to this embodiment of the present invention, the first and second video conference participant terminals 142 and 144 are connected to the first OpenFlow switch 122, the third video conference participant terminal 146 is connected to the second OpenFlow switch 124, and the fourth video conference participant terminal 148 is connected to the third OpenFlow switch 126.

Although the system according to this embodiment of the present invention has been described as including the three OpenFlow switches and the four participant terminals as an example, the system is not limited thereto.

Referring to FIG. 1, the controller 130 may configure respective flow tables in the first, second and third OpenFlow switches 122, 124 and 126, and may communicate with the first, second and third OpenFlow switches 122, 124 and 126 based on the OpenFlow protocol. In this case, the specifications for the OpenFlow protocol may be defined and updated by ONF, which is a standardization organization.

The controller 130 may generate information about network topology and the configurations of the respective OpenFlow switches 122, 124 and 126 in conjunction with the first, second and third OpenFlow switches 122, 124 and 126. Furthermore, when requests for participation in a video conference have been received, the controller 130 may construct a ring-type transmission path table, and may then set the transmission path information of the ring-type transmission path table in the first, second and third OpenFlow switches 122, 124 and 126 that are used for the video conference. In this case, the entries of each transmission path set in the first, second and third OpenFlow switches 122, 124 and 126 include an input multicast IP address and output switch port information. Each of the OpenFlow switches 122, 124 and 126 transfers related traffic (packet) from its input port to its output port, and then copies the packet once at the output port. The original packet is transmitted to a participant terminal that will receive the packet, whereas the copied packet is transmitted to another OpenFlow switch on the ring-type transmission path via loopback. Accordingly, the packet received from the OpenFlow switch may be transmitted through a ring-type transmission path 150.

Meanwhile, the path is set up using the transmission path information set in the OpenFlow switches 122, 124 and 126 by the controller 130, thereby enabling the ring-type transmission path 150 to be set up.

Although the single controller 130 has been described as controlling the plurality of OpenFlow switches in this embodiment of the present invention as an example as described above, a plurality of controllers may control the plurality of OpenFlow switches 122, 124 and 126.

The first, second, third and fourth video conference participant terminals 142, 144, 146 and 148 may be connected by the first, second and third OpenFlow switches 122, 124 and 126, and may transmit video conference traffic to the first, second and third OpenFlow switches 122, 124 and 126. In this case, although the term “video conference traffic” may be defined as one or more packets (multicast traffic) having a multicast IP address, it is not limited thereto. That is, video conference traffic may be defined in various types of format.

Meanwhile, each of the first, second and third OpenFlow switches 122, 124 and 126 sets up a path based on the path information generated by the controller 130, and thus the ring-type transmission path 150 may be set up. Through the ring-type transmission path 150, the first, second and third OpenFlow switches 122, 124 and 126 may process the multicast traffic received from the first, second, third and fourth video conference participant terminals 142, 144, 146 and 148, and may provide video conference service to a plurality of participants.

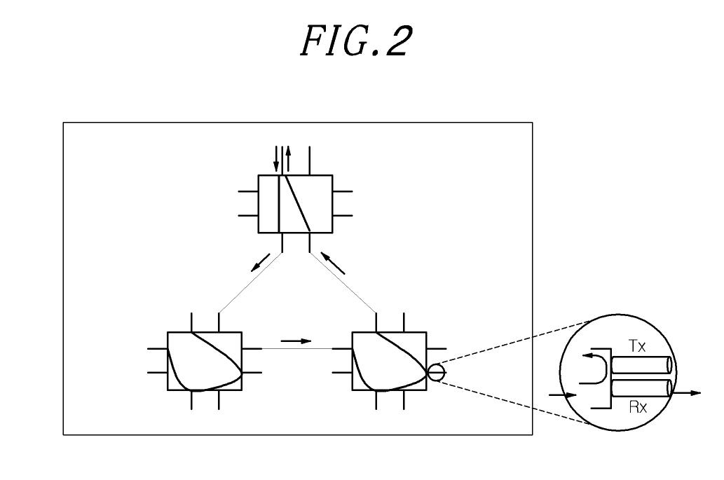

The transmission path information that is used to set up the ring-type transmission path 150 by the first, second and third OpenFlow switches 122, 124 and 126 and set in each of the first, second and third OpenFlow switches 122, 124 and 126 may be illustrated as illustrated in FIG. 2.

When the multicast traffic, for example, video conference traffic, is received from the first, second, third and fourth video conference participant terminals 142, 144, 146 and 148, the first, second and third OpenFlow switches 122, 124 and 126 determine whether forwarding information (transmission path information) regarding the multicast traffic is present, and transmits the multicast traffic to the controller 130 if the forwarding information is not present.

Meanwhile, when multicast traffic is received from any OpenFlow switch, the controller 130 constructs a ring-type transmission path table using the information about network topology and the configurations of the first, second and third OpenFlow switches 122, 124 and 126 on the network 110. The transmission path information within the ring-type transmission path table constructed as described above may be transmitted to the first, second and third OpenFlow switches 122, 124 and 126, and may be set in flow tables inside the first, second and third OpenFlow switches 122, 124 and 126.

Meanwhile, when the ring-type transmission path is set up, the controller 130 may select a path that satisfies required bandwidth requirements, through which a path in which Quality of Service (QoS) is guaranteed can be set up.

Furthermore, the controller 130 may set up a transmission path of improved survivability by adding a ring that has a direction opposite the direction of transmission of traffic.

Meanwhile, the ring-type transmission path 150 according to an embodiment of the present invention allows the video conference participant terminals corresponding to senders to receive transmitted packets, thereby enabling the state of the network and the quality of traffic to be easily evaluated.

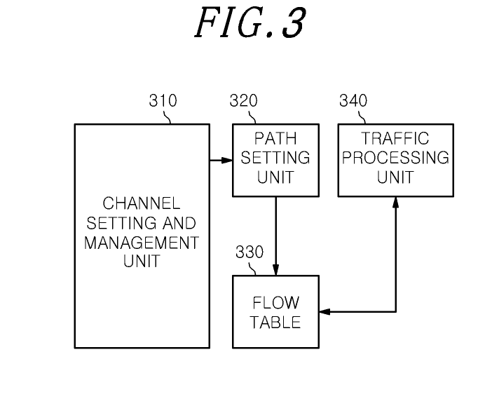

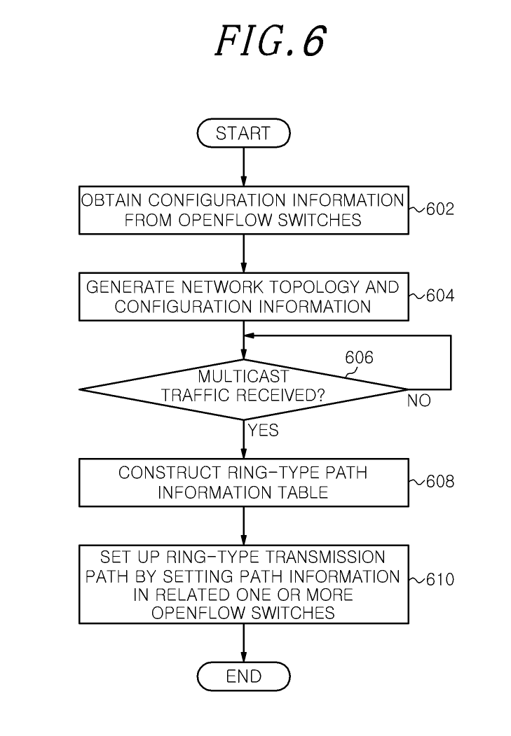

Next, the internal configuration and operation of the OpenFlow switch and the controller 130 that are used to set up a ring-type transmission path and provide video conference service through this ring-type transmission path according to an embodiment of the present invention will be described with reference to FIGS. 3 and 6.

FIG. 3 is a block diagram illustrating the internal configuration of an OpenFlow switch according to an embodiment of the present invention.

Referring to FIG. 3, the OpenFlow switch is a transmission device that receives traffic and transmits it through a transmission path, and may include a channel setting and management unit 310, a path setting unit 320, a flow table 330, and a traffic processing unit 340.

The channel setting and management unit 310 may perform the setup and management of a channel in order to operate in conjunction with the controller 130.

The channel setting and management unit 310 sets up a Secure Socket Layer (SSL)-based security channel in conjunction with the controller 130, and may receive data, for example, ring-type transmission path information, from the controller 130 over the security channel.

The path setting unit 320 may receive the transmission path information from the controller 130, and may set the transmission path information in the flow table 330.

The traffic processing unit 340 transfers the original packet corresponding to the traffic received through the input port to the output port, copies the original packet at the output port, and transmits the original packet to the participant terminals 142, 144, 146 and 148 and also to the OpenFlow switch via loopback, thereby transmitting it to other OpenFlow switches based on the transmission path information in the flow table 330.

The flow table 330 is constructed pursuant to the specifications of the OpenFlow protocol, and may include flow entries including match fields, counters, and instructions.

As described above, the traffic processing unit 340 may process multicast traffic based on the transmission path information set in the flow table 330.

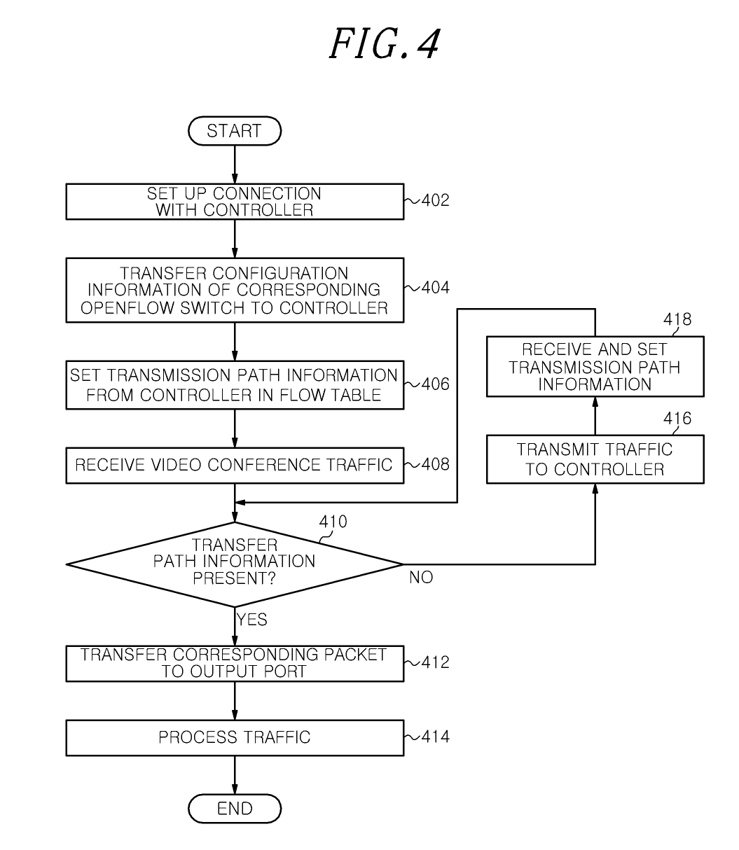

The operation of the OpenFlow switch configured as described above will be described with reference to FIG. 4.

FIG. 4 is a flow chart illustrating the operation of the OpenFlow switch according to an embodiment of the present invention.

Referring to FIG. 4, once the OpenFlow switch has been initially operated, the OpenFlow switch sets up a connection with the controller 130 using the OpenFlow protocol at step 402.

After the connection has been set up, the OpenFlow switch transmits the configuration information to the controller 130 at step 404. Thereafter, the OpenFlow switch receives path information from the controller 130 and then sets the path information in the flow table 330 at step 406.

Thereafter, when multicast traffic, for example, video conference traffic, is received at step 408, the OpenFlow switch determines whether transmission path information matching the multicast traffic is present in the flow table 330 at step 410.

If, as a result of the determination at step 410, it is determined that the matching transmission path information is present, the OpenFlow switch transfers the packet corresponding to the multicast traffic to the output port at step 412, and copies the corresponding packet at the output port and transfers it to other OpenFlow switches via loopback, thereby transmitting the copied packet to other OpenFlow switches based on the transmission path information in the flow table 330 and processing the multicast traffic at step 414.

Meanwhile, if, as a result of the determination at step 410, it is determined that the matching transmission path information is not present, the OpenFlow switch transfers the corresponding packet to the controller 130 at step 416, receives transmission path information in response to the corresponding packet, sets the received transmission path information in the flow table 330 at step 418, returns to step 410, and then determines whether transmission path information matching the multicast packet is present in the flow table 330.

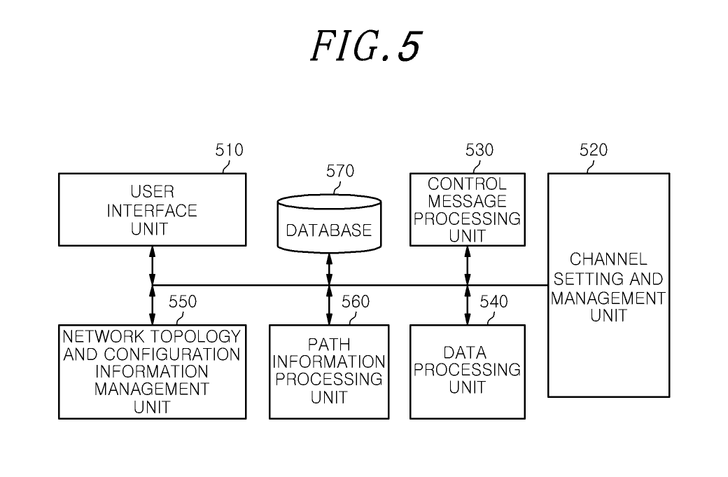

FIG. 5 is a block diagram illustrating the internal configuration of a controller according to an embodiment of the present invention.

Referring to FIG. 5, the controller 130 may include a user interface unit 510, a channel setting and management unit 520, a control message processing unit 530, a data processing unit 540, a network topology and configuration information management unit 550, a path information processing unit 560, and a database 570.

The user interface unit 510 may provide an interface that enables information, such as policies from a network administrator, to be set.

The channel setting and management unit 520 may provide the functions of setting and managing channels that are used to operate in conjunction with the OpenFlow switches. In this case, the term corresponding channels refers to SSL-based security channels.

The control message processing unit 530 provides the function of processing control messages that are exchanged between the controller 130 and the OpenFlow switches 122, 124 and 126.

The data processing unit 540 provides the function of processing the traffic that is transmitted to the controller 130 because there is no match in the flow tables 330 of the OpenFlow switches.

The network topology and configuration information management unit 550 provides the function of generating information about network topology and the configurations of the related switches based on the information about the configurations of the switches received from the OpenFlow switches.

When multicast traffic, that is, requests for participation in a video conference, is received, the path information processing unit 560 constructs a ring-type transmission path table used to transmit the related multicast traffic based on the generated information about network topology and the configurations of the related switches, and transmits transmission path information in the ring-type transmission path table to the corresponding OpenFlow switches to thereby set up a ring-type transmission path. When the ring-type transmission path table is constructed, a path satisfying required bandwidth requirements is selected, and thus a path guaranteeing QoS can be set up. Furthermore, the path information processing unit 560 may set up a transmission path by adding a ring having a direction opposite the generated direction of transmission of traffic.

A transmission path of improved survivability may be generated by adding the ring having the opposite direction.

The database 570 provides the function of storing and managing the network topology and configuration information and the path information.

The operation of the controller 130 configured as described above will be described with reference to FIG. 6.

FIG. 6 is a flow chart illustrating the operation of the controller 130 according to an embodiment of the present invention.

Referring to FIG. 6, when the controller 130 connects with the OpenFlow switches pursuant to the OpenFlow protocol, the controller 130 obtains configuration information from the OpenFlow switches at step 602, and then generates network topology and configuration information at step 604.

Thereafter, when multicast traffic is received from any OpenFlow switch at step 606, the controller 130 constructs a ring-type transmission path table based on the network topology and configuration information at step 608, and then transmits transmission path information in the ring-type transmission path table to the individual OpenFlow switches to thereby set the transmission path information of the OpenFlow switches, thereby setting up a ring-type transmission path at step 610. The individual OpenFlow switches along the ring-type transmission path process multicast traffic received from the participant terminals 142, 144, 146 and 148 using the transmission path information. In this case, although traffic used to provide video conference service may be taken as an example of the multicast traffic, the multicast traffic is not limited thereto.

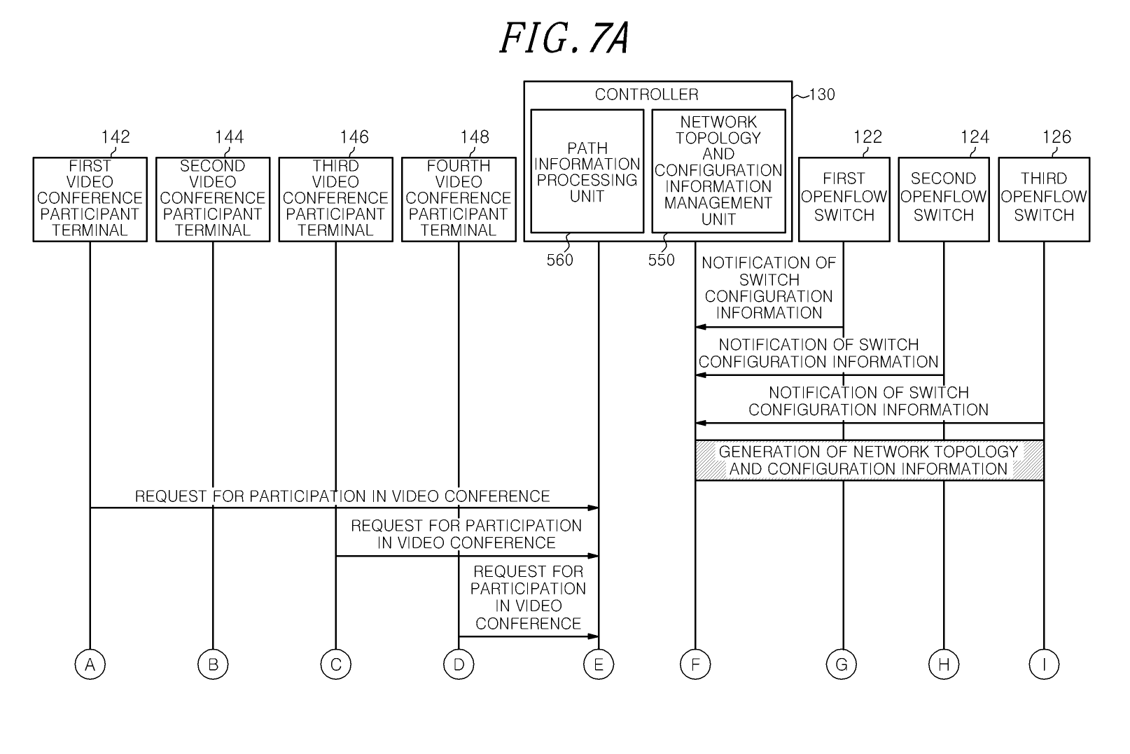

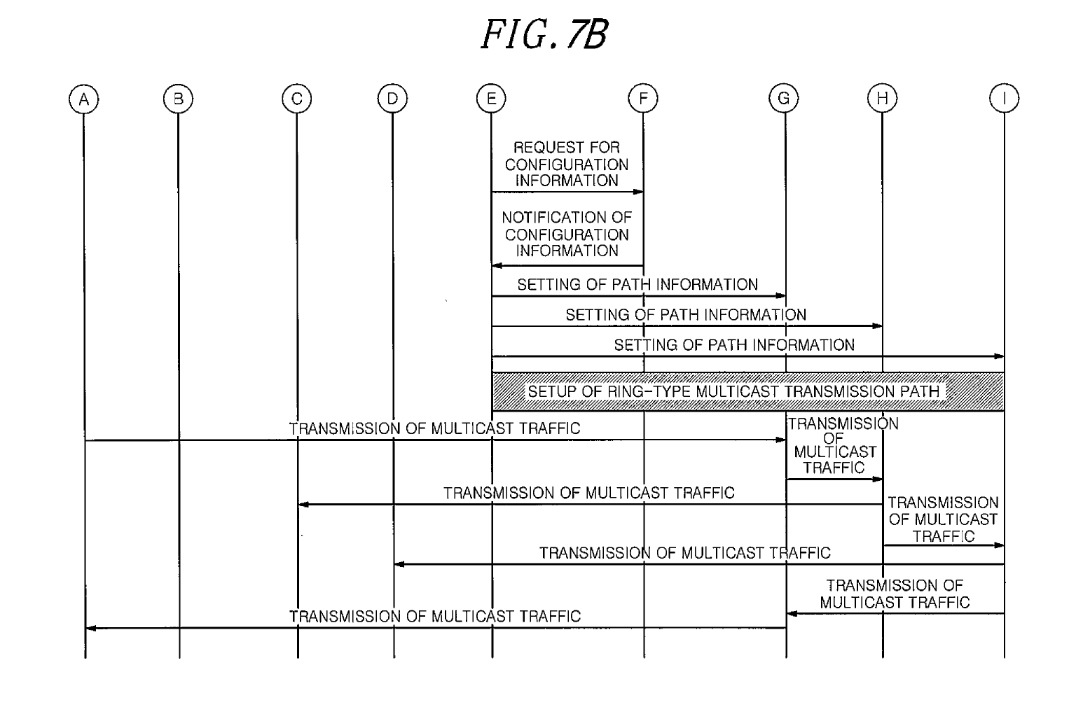

Meanwhile, an overall process of processing multicast traffic, for example, traffic for a video conference, using the first, second and third OpenFlow switches 122, 124 and 126 and the controller 130 illustrated in FIG. 1 will be described with reference to FIGS. 7A and 7B.

FIGS. 7A and 7B are flow charts illustrating a process of providing video conference service according to an embodiment of the present invention.

Referring to FIGS. 7A and 7B, prior to the provision of video conference service, the configuration information management unit 550 of the controller 130 receives configuration information from the first, second and third OpenFlow switches 122, 124 and 126, and then generates network topology and configuration information.

Thereafter, when messages requesting participation in a video conference are received from the first, third and fourth video conference participant terminals 142, 146 and 148, the path information processing unit 560 of the controller 130 requests the network topology and configuration information from the configuration information management unit 550 and receives it.

Thereafter, the path information processing unit 560 constructs a ring-type path information table based on the network topology and configuration information, and transmits the ring-type path information to the first, second and third OpenFlow switches 122, 124 and 126, thereby setting up a ring-type transmission path.

Thereafter, when the first video conference participant terminal 142 transmits multicast traffic to the first OpenFlow switch 122, the first OpenFlow switch 122 processes the multicast traffic based on transmission path information. That is, the first OpenFlow switch 122 transfers the packet corresponding to the multicast traffic to the output port, copies the packet at the output port, and then transmits the original packet to the third video conference participant terminal 146. Thereafter, the first OpenFlow switch 122 receives the copied packet via loopback, and transmits it to the second OpenFlow switch 124.

The second OpenFlow switch 124 transmits the packet received from the first OpenFlow switch 122 to the fourth video conference participant terminal 148, receives the copied packet via loopback, and transmits the copied packet to the third OpenFlow switch 126 in the same manner as the first OpenFlow switch 122. The third OpenFlow switch 126 transmits the packet received from the second OpenFlow switch 124 to the first video conference participant terminal 142 through the first OpenFlow switch 122.

As described above, the multicast traffic transmitted by the first video conference participant terminal 142 is transmitted to the third and fourth video conference participant terminals 146 and 148 that requested participation in the video conference through the first, second and third OpenFlow switches 122, 124 and 126, and can be finally transmitted to the first video conference participant terminal 142 that initially transmitted the multicast traffic.

The present invention is advantageous in that a ring-type transmission path is set up using OpenFlow switches and multicast traffic is processed through the ring-type transmission path, thereby providing service using multicast traffic while minimizing a network bandwidth.

Furthermore, the present invention is advantageous in that traffic is transmitted to a terminal that transmitted the traffic through a ring-type transmission path, thereby facilitating the evaluation of the state of a network and the quality of traffic.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for processing multicast traffic in an OpenFlow environment, comprising:
a network topology and configuration information management unit configured to generate network topology and related switch configuration information based on switch configuration information received from one or more OpenFlow switches; and.
a path information processing unit configured to, when traffic for video conference service is received, generate ring-type transmission path information to be used to process the traffic, based on the network topology and related switch configuration information, and set the ring-type transmission path information in one or more OpenFlow switches to be used for the video conference service, thereby setting up a ring-type transmission path.

2. The apparatus of claim 1, wherein the path information processing unit generates the ring-type transmission path information that guarantees Quality of Service (QoS) while satisfying required bandwidth requirements.

3. The apparatus of claim 1, further comprising a channel setting and management unit configured to set up security channels with the OpenFlow switches and transmit and receive data over the security channels.

4. An apparatus for processing multicast traffic in an OpenFlow environment, comprising:
a flow table configured such that transmission path information used to process external traffic has been set therein; and
a path setting unit configured to, when traffic that does not match the flow table is received, transmit the received traffic to a controller, receive transmission path information to be used to process the traffic from the controller, set the received transmission path information in the flow table, and set up a ring-type transmission path with one or more OpenFlow switches related to the traffic based on the transmission path information set in the flow table.

5. The apparatus of claim 4, further comprising a traffic processing unit configured to copy the original packet corresponding to the received traffic, and to transmit the original packet to a terminal corresponding to a destination and also transmit the copied packet to other OpenFlow switches on the ring-type transmission path.

6. The apparatus of claim 5, wherein the packet corresponding to the received traffic is transmitted to a terminal that transmitted the received traffic, through the ring-type transmission path.

7. The apparatus of claim 4, further comprising a channel setting and management unit configured to operate in conjunction with the controller over a Secure Socket Layer (SSL)-based security channel.

8. The apparatus of claim 4, wherein the received traffic is multicast traffic for a video conference.

9. A method of processing multicast traffic in an OpenFlow environment, comprising:
when multicast traffic is received from an outside source, requesting transmission path information that is used to process the multicast traffic;
receiving ring-type transmission path information in response to the request; and
setting up a ring-type transmission path with one or more other OpenFlow switches for processing of the multicast traffic using the ring-type transmission path information;
wherein the multicast traffic is processed through the ring-type transmission path.

10. The method of claim 9, wherein said requesting transmission path information comprises:
determining whether the transmission path information to be used to process the multicast traffic is present in a flow table; and
if the transmission path information is not present in the flow table, requesting the transmission path information.

11. The method of claim 9, further comprising:
copying the original packet corresponding to the multicast traffic, and then transmitting the original packet to a terminal corresponding to a destination address of the traffic; and
transmitting the copied packet to other OpenFlow switches on the ring-type transmission path.

12. The method of claim 9, wherein the packet corresponding to the multicast traffic is transmitted to a terminal that transmitted the multicast traffic, through the ring-type transmission path.

13. The method of claim 9, further comprising:
obtaining configuration information from a plurality of OpenFlow switches, and generating network topology and configuration information based on the configuration information;
when traffic for a video conference is received, generating ring-type transmission path information based on the network topology and configuration information; and
setting up a ring-type transmission path by setting the generated ring-type transmission path information in one or more OpenFlow switches for the video conference.

14. The method of claim 13, wherein said generating ring-type transmission path information comprises generating the ring-type transmission path information that guarantees Quality of Service (QoS) while satisfying required bandwidth requirements.
